(19) United States
(12) Patent Application Publication
(10) Pub. No.: US 2017/0323366 A1
(43) Pub. Date: Nov. 9, 2017

(54) Bundles by her

(71) Applicants: Jeremy Boyd, Atlanta, GA (US); Alvin Crews, Fort Washington, MD (US)

(72) Inventors: Jeremy Boyd, Atlanta, GA (US); Alvin Crews, Fort Washington, MD (US)

(21) Appl. No.: 14/998,919

(22) Filed: May 9, 2016

(51) Int. Cl. G06Q 30/06; G06Q 50/00; G06Q 30/02

(52) U.S. Cl. CPC G06Q 30/0627; G06Q 50/01; G06Q 30/0282; G06Q 30/0633; G06Q 30/0643

(57) ABSTRACT

The present invention may be used for creating an access point for hair vendors and customers to sell and buy affordable and excellent quality hair bundles in their current location. Users can search for hair bundles in any zip code, by using a built in search feature within the Application, that can filter by location and price. In addition, a built in database, stores vendors hair bundle information and pictures. Then this will populate the hair bundle results that are obtained when using the search function. A review and rating feature will help users determine the best quality bundle of hair to buy. Once a hair bundle is selected a user can checkout via a secure payment method, PayPal.

### BACKGROUND OF THE INVENTION

This invention relates to a mobile application that creates an access point for hair vendors and customers to buy and sell top quality hair bundles in their area. Good quality hair is so hard to find and when you find it the supply is always limited. This invention is designed to allow users to always find hair bundles and vendors, in their present location, conveniently. In addition this application will carry a range of hair textures and designs from Remy, Human Hair, Wigs, Etc. This application will be called Bundles By Her.

### SUMMARY OF THE INVENTION

Users of the Application will search for bundles through a search function built within the Application. Bundles will be easily searchable by entering location, color, length, and type. This function will pull data from a built in storage database that will house vendors product information, such as bundle types. In addition, all images, description of product, location, and quantities of the hair bundles that are in stock, will be uploaded by Hair Vendors. After a user receives the search results, they can sort by price, ratings, and view pictures of inventory. There will be a feature within the Application designed to allow users to write reviews and rate the vendor products after receiving the product. A user will rate a hair product from one to five stars based on the quality of hair. In addition, this rating and review feature allows users to view and choose the best quality hair bundle in their area.

Another feature will be notifications of inventory. For example, a vendor gets Brazilian hair in stack and would like to cater to a certain group of people. Then a notification will be sent from the vendor to that group of people for that specific product. Before checkout users can view stylist in the area to install their hair. Users will get notified when the stylist is late. Also, they will get notified before and after their hair appointment to rate the application. After choosing a product, users can pay via a secure payment method such as PayPal. They can choose to share the Application via social media such as Facebook.

### BRIEF DESCRIPTION OF THE DRAWINGS

The following description is better understood when read in conjunction with the appended drawings.

FIG. 1 is the login screen of the mobile application.

FIG. 2 is the screen users see when choosing to search for a hair bundle.

FIG. 3 is the screen users see that will sort their results by location, type, color, and hair length.

FIG. 4 is the screen users see the hair bundles images, price, and ratings of the hair product.

FIG. 5 is the screen users see after selecting a hair product and adding it to a shopping cart for purchase.

FIG. 6 is the screen users see to add their billing and shipping information.

FIG. 7 is the screen users see when selecting a payment method.

FIG. 8 is the screen users see to add messages, share posts, and ratings.

FIG. 9 is the screen administrators see to check their inbox for messages.

FIG. 10 is the screen users see when choosing become a vendor, upload inventory, etc.

FIG. 11 is the screen hair vendors see after selecting become a vendor.

FIG 12 is the screen hair vendors see after selecting upload your inventory.

### DETAILED DESCRIPTION

An embodiment of the present hair bundle mobile application is designed to create an access point for users and hair vendors. The description is not intended to limit the scope of the subject matter. The following description is for illustrative purposes only.

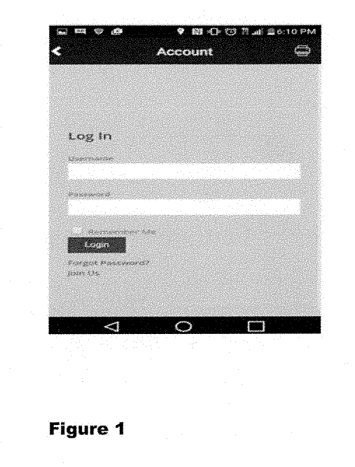

FIG. 1 is the login screen of the mobile application. Users can register and click on this screen in the designated area if they forget their password.

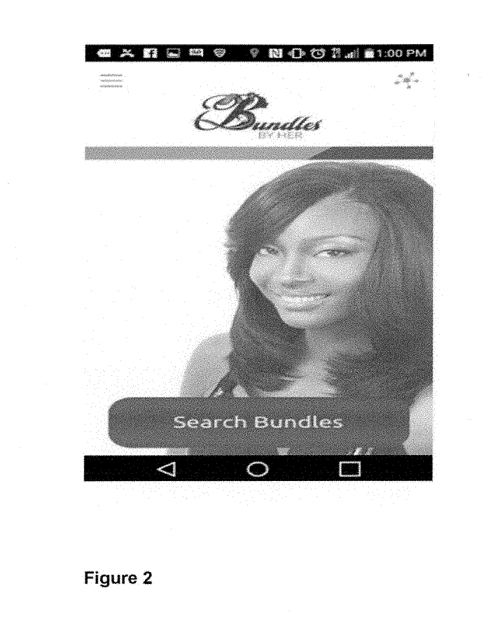

FIG. 2 is the screen a user sees after logging in the mobile application. This screen allows users to search for hair bundles.

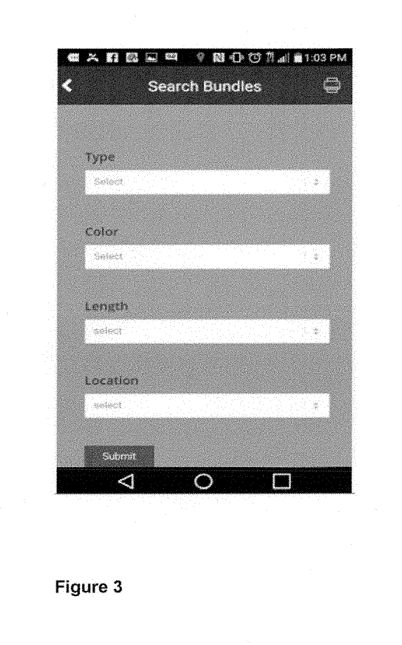

FIG. 3 is the screen a user sees to filter their search results. On this screen a user can filter their search by location, color, length, and type of hair bundle.

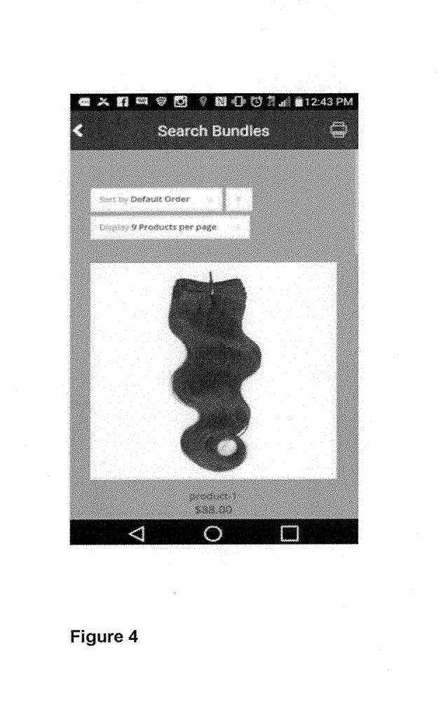

FIG. 4 is the screen that displays the image of the hair bundle, price, vendor information, and rating. This information is populated from the search results. This is due to the mobile application having a built in database that houses vendor's hair information.

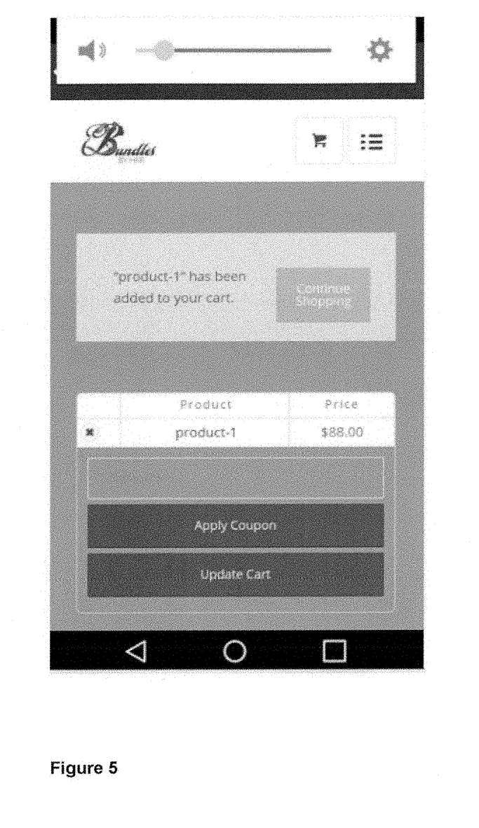

FIG. 5 is the screen that populates a shopping cart for users to add a hair product and quantity amount to purchase.

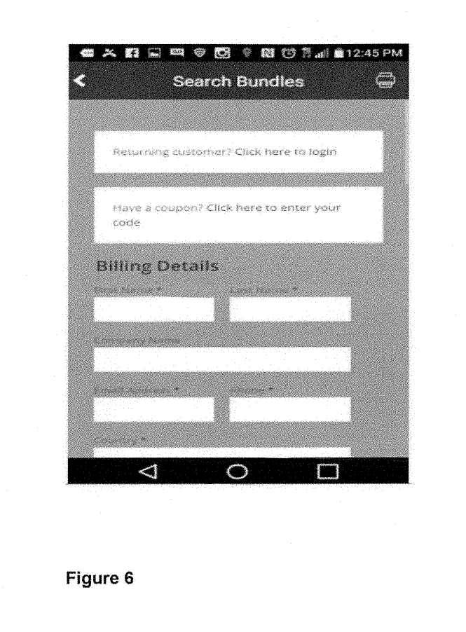

FIG. 6 is the screen that requests users to enter their billing and shipment information.

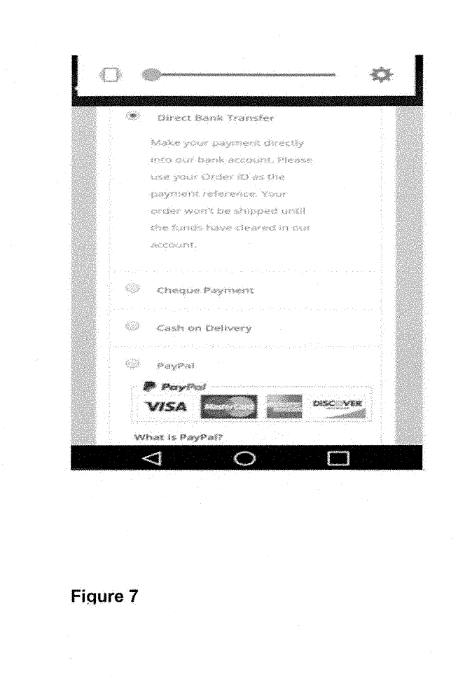

FIG. 7 is the screen which directs users to a secure payment method to pay for their transaction, PayPal.

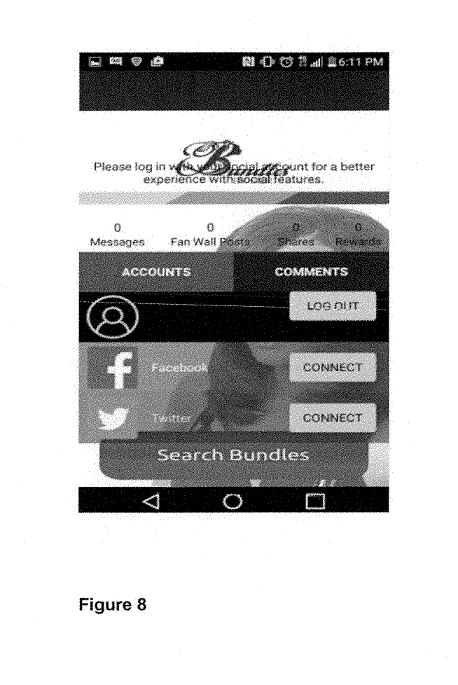

FIG. 8 is the screen that allows users to write comments, provide ratings, share the mobile application to their social media, and logout.

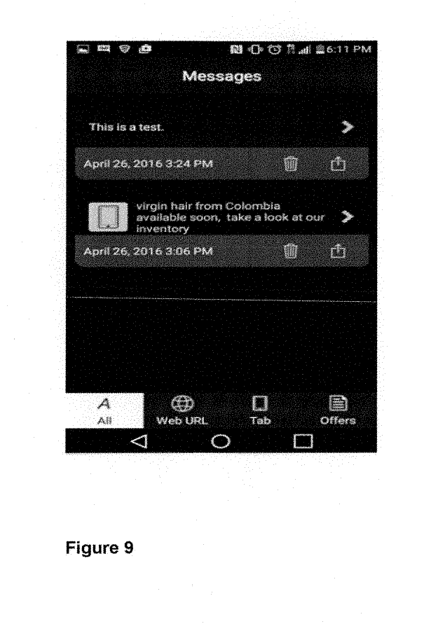

FIG. 9 is the screen administrators see when checking their inbox for messages from vendors and users.

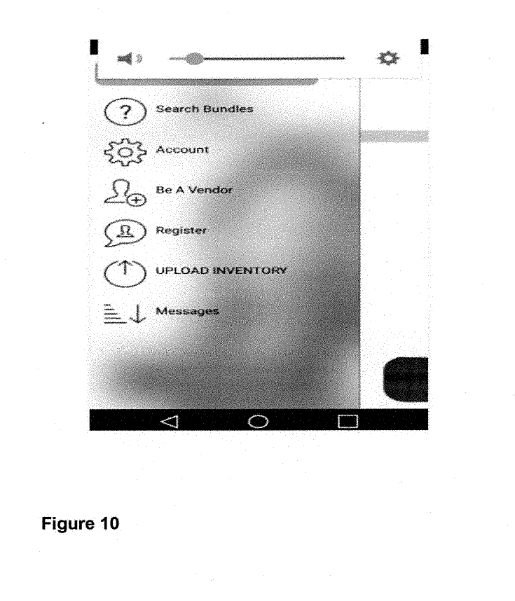

FIG. 10 is the screen users select to register, login, and search for hair bundles. In addition, on this screen vendor can register and upload inventory. Last, this screen is a convenient way for administrators to check their messages.

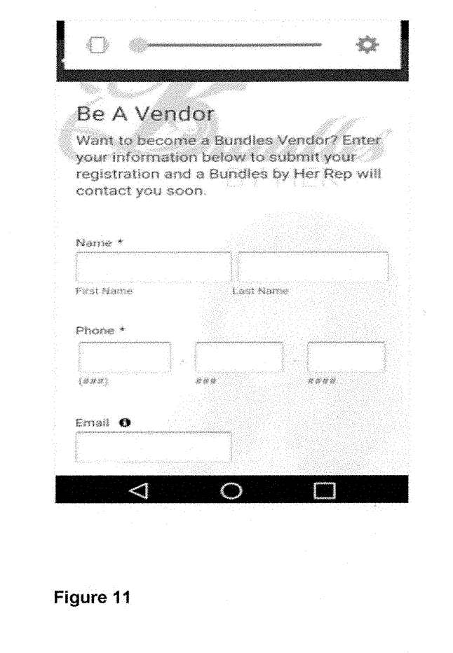

FIG. 11 is populates when a vendor is registering as a vendor on the mobile application.

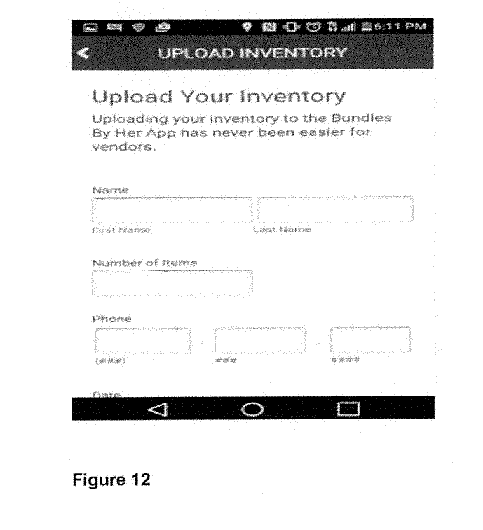

FIG. 12 populates after a vendor registers allowing users to upload their inventory.

This specification contains no new matter.

What is claimed is:

1. A device for a mobile phone, comprising:
Receiving, by a processor, a search request to find hair bundles;
Displaying, by the processor, a sort function to filter results;
Receiving, by the processor, a hair bundle selection;
Displaying, by the processor, the image and shopping cart on the mobile device;
Receiving, by the processor, a request to purchase the selected hair bundle;
Generating, by the processor, a purchase order for the hair bundle;
Receiving, by the processor, a request to rate and write a review of the hair bundle purchased;
Displaying, by the processor, a rate and comment box;
Receiving, by the processor, an alert request to notify users when a specific product is in stuck;
Displaying, by the processor, a notification sent from the mobile application to selected users;
Receiving, by the processor, a request to share the mobile application to social media;
Displaying, by the processor, a share to Facebook, Twitter, and Instagram feature.

2. The method of claim 1, further comprising receiving, by the processor, a request to locate and purchase hair bundles.

3. The method of claim 1, further comprising, by the processor, a filtering and sort feature to sort hair bundles by location, ratings, and price.

4. The method of claim 1, further comprising receiving, by the processor, a hair bundle selection from user.

5. The method of claim 1, further comprising, by the processor a hair bundle image and a shopping cart icon to add the product.

6. The method of claim 1, further comprising, by the processor, a hair bundle added to the shopping cart for check out.

7. The method of claim 1, further comprising, by the processor, a request for users to enter billing and payment information.

8. The method of claim 1, further comprising, by the processor, a notification to rate and write reviews on the hair bundle purchased.

9. The method of claim 1, further comprising, by the processor, a rate and comment box.

10. The method of claim 1, further comprising, by the processor, a user request for vendor merchandise notification.

11. The method of claim 1, further comprising, by the processor, notification alerts sent to selected users from the mobile application.

12. The method of claim 1, further comprising, by the processor, a request from user to share the mobile application via social media.

13. The method of claim 1, further comprising, by the processor, a share to Facebook, Twitter, and Instagram button.
